(19) United States
(12) Patent Application Publication
(10) Pub. No.: US 2023/0408067 A1
(43) Pub. Date: Dec. 21, 2023

(54) BACKLIGHT MODULE AND DISPLAY APPARATUS

(71) Applicant: Unique Materials Co., Ltd., Taipei City (TW)

(72) Inventors: Huan-Wei Tseng, Taipei City (TW); Chun-Wei Chou, Taipei City (TW); Chia-Chun Liao, Taipei City (TW)

(73) Assignee: Unique Materials Co., Ltd., Taipei City (TW)

(21) Appl. No.: 18/180,870

(22) Filed: Mar. 9, 2023

Related U.S. Application Data
(60) Provisional application No. 63/353,851, filed on Jun. 21, 2022.

(30) Foreign Application Priority Data
Sep. 20, 2022 (TW) 111135568

(51) Int. Cl. F21V 9/30; F21V 8/00

(52) U.S. Cl. CPC F21V 9/30; G02B 6/0046

(57) ABSTRACT

A backlight module and a display apparatus are provided. The backlight module includes a quantum fluorescent film. The quantum fluorescent film includes a light conversion layer. The light conversion layer includes a resin material, a plurality of quantum dots and a plurality of phosphors. The plurality of quantum dots and the plurality of phosphors are dispersed in the resin material.

### CROSS-REFERENCE TO RELATED APPLICATION

This application claims the priority benefits of U.S. provisional application Ser. No. 63/353,851, filed on Jun. 21, 2022 and Taiwan application serial no. 111135568, filed on Sep. 20, 2022. The entirety of each of the above-mentioned patent applications is hereby incorporated by reference herein and made a part of this specification.

### BACKGROUND

### Technical Field

The present invention relates to a light-emitting apparatus, and particularly to a backlight module and a display apparatus including a light conversion layer.

### Description of Related Art

A quantum dot is an extremely tiny semiconductor nanostructure that cannot be seen by the naked eye. When the quantum dot is excited by light, the quantum dot emits colored light, and the color of the light emitted is determined by the material, the size and the shape of the quantum dot. In other words, the quantum dot may change the color of the light emitted by the light source, depending on the above properties of the quantum dot. Therefore, in recent years, the light conversion layer containing quantum dots has been widely used in the backlight module and the display apparatus.

### SUMMARY

The present invention provides a backlight module containing a quantum fluorescent film, wherein the quantum fluorescent film includes a light conversion layer, and the light conversion layer includes a resin material with quantum dots and phosphors dispersed therein.

A backlight module of the present invention includes a quantum fluorescent film. The quantum fluorescent film includes a light conversion layer. The light conversion layer includes a resin material, a plurality of quantum dots and a plurality of phosphors. The plurality of quantum dots and the plurality of phosphors are dispersed in the resin material.

In an embodiment of the backlight module of the present invention, the backlight module further includes a light source and a light guide plate. The light source emits blue light. The light guide plate is optically coupled with the light source. The quantum fluorescent film is disposed on a light emitting surface of the light guide plate.

In an embodiment of the backlight module of the present invention, the light source is disposed adjacent to a side surface of the light guide plate to form an edge-lit structure.

In an embodiment of the backlight module of the present invention, the light source is disposed adjacent to a back surface of the light guide plate to form a direct-lit structure.

In an embodiment of the backlight module of the present invention, the quantum fluorescent film further includes a first substrate and a second substrate, and the light conversion layer is disposed between the first substrate and the second substrate.

In an embodiment of the backlight module of the present invention, the first substrate comprises a gas barrier layer.

In an embodiment of the backlight module of the present invention, the first substrate does not comprise a gas barrier layer.

In an embodiment of the backlight module of the present invention, the second substrate comprises a gas barrier layer.

In an embodiment of the backlight module of the present invention, the second substrate does not comprise a gas barrier layer.

In an embodiment of the backlight module of the present invention, the backlight module further includes an optical film disposed on the quantum fluorescent film.

In an embodiment of the backlight module of the present invention, the optical film includes a brightness enhancement film, a diffuser film, a polarizer film or a combination thereof.

In an embodiment of the backlight module of the present invention, the resin material includes acrylic resin, epoxy resin, silicone or a combination thereof.

In an embodiment of the backlight module of the present invention, the quantum dot has a core-gradient alloy layer-shell structure.

In an embodiment of the backlight module of the present invention, a material of a core of the quantum dot includes CdSe or InP.

In an embodiment of the backlight module of the present invention, a material of a shell of the quantum dot includes ZnSe or ZnS.

In an embodiment of the backlight module of the present invention, the plurality of quantum dots includes green quantum dots, red quantum dots or a combination thereof.

In an embodiment of the backlight module of the present invention, the plurality of phosphors includes green phosphors, red phosphors or a combination thereof.

In an embodiment of the backlight module of the present invention, a material of the green phosphor includes (Ba,Sr)₂SiO₄:Eu²⁺, Si_{6-z}Al_{z}O_{z}N_{8-z}:Eu²⁺, Al₁₇O_{2.1}N_{0.3}:Mn²⁺,Eu²⁺ or a combination thereof.

In an embodiment of the backlight module of the present invention, a material of the red phosphor includes CaAlSiN₃:Eu²⁺, Sr₂Si₅N₈:Eu²⁺, K₂SiF₆:Mn⁴⁺ or a combination thereof.

A display apparatus of the present invention includes a display panel and the backlight module of the present invention. The backlight module is disposed on a side of the display panel.

Based on the above, in the backlight module of the present invention, the light conversion layer contains the resin material with a plurality of quantum dots and a plurality of phosphors dispersed in the resin material. Therefore, the backlight module including the light conversion layer may have a wider color gamut and a lower cadmium content.

To make the aforementioned more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1 is a schematic cross-sectional view of a display apparatus of the first embodiment of the present invention.

FIG. 2 is a schematic cross-sectional view of a quantum fluorescent film in the display apparatus of FIG. 1.

FIG. 3 is a schematic cross-sectional view of a display apparatus of the second embodiment of the present invention.

FIG. 4 shows white light emission spectra of the display apparatuses of the Experimental examples and the Comparative example.

FIG. 5A is a color gamut diagram of the Experimental example 1.

FIG. 5B is a color gamut diagram of the Comparative example 1.

### DESCRIPTION OF THE EMBODIMENTS

The embodiments are described in detail below with reference to the accompanying drawings, but the embodiments are not intended to limit the scope of the present invention. In addition, the drawings are for illustrative purposes only and are not drawn to the original dimensions. For the sake of easy understanding, the same elements in the following description will be denoted by the same reference numerals.

In the text, the terms mentioned in the text, such as “comprising”, “including”, “containing” and “having” are all open-ended terms, i.e., meaning “including but not limited to”.

When using terms such as “first” and “second” to describe elements, it is only used to distinguish the elements from each other, and does not limit the order or importance of the devices. Therefore, in some cases, the first element may also be called the second element, the second element may also be called the first element, and this is not beyond the scope of the present invention.

In addition, the directional terms, such as “on”, “above”, “under” and “below” mentioned in the text are only used to refer to the direction of the drawings, and are not used to limit the present invention.

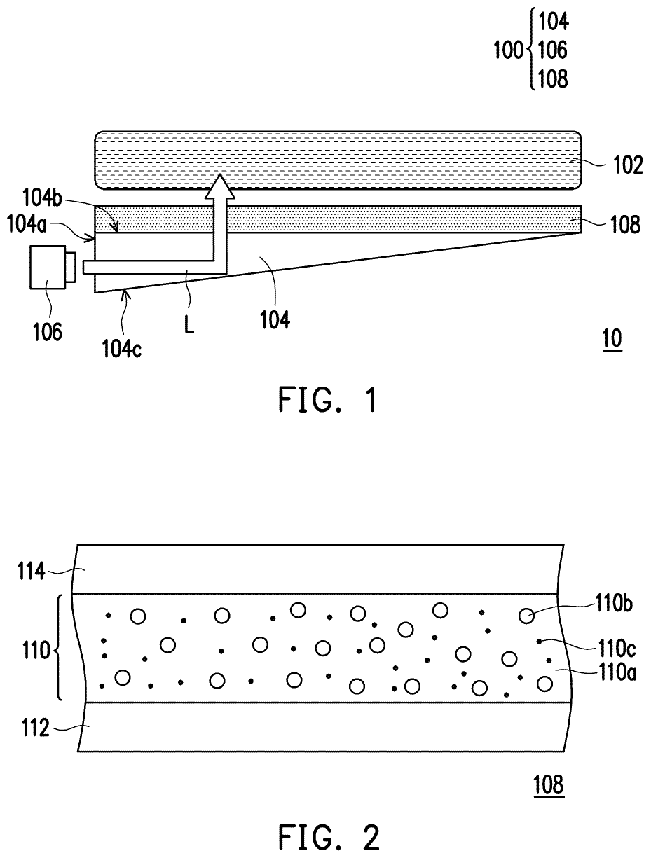

FIG. 1 is a schematic cross-sectional view of a display apparatus of the first embodiment of the present invention. FIG. 2 is a schematic cross-sectional view of a quantum fluorescent film in the display apparatus of FIG. 1.

Referring to FIGS. 1 and 2, in the present embodiment, a display apparatus 10 includes a backlight module 100 and a display panel 102. The backlight module 100 may include a light guide plate 104, a light source 106 and a quantum fluorescent film 108. The display panel 102 may be a liquid crystal display panel. The detailed structure of the display panel 102 is well known to those skilled in the art, and will not be further described herein. The backlight module 100 is disposed on one side of the display panel 102.

In the present embodiment, the cross section of the light guide plate 104 has a triangular shape. In detail, in the present embodiment, the light guide plate 104 has a light incident surface 104a, a light emitting surface 104b and a back surface 104c, wherein the angle between the light incident surface 104a and the light emitting surface 104b is a right angle, and the light emitting surface 104b is opposite to the back surface 104c, but the present invention is not limited thereto. In other embodiments, the cross-section of light guide plate 104 may have other suitable shapes. In the present embodiment, the light incident surface 104a may be regarded as the side surface of the light guide plate 104. The material of the light guide plate 104 may be glass, polymethylmethacrylate (PMMA), polycarbonate (PC), polyethylene terephthalate (PET), polyimide (PI) or other suitable material. In addition, depending on actual needs, a reflective layer (not shown) or other component may be disposed at the back surface 104c of the light guide plate 104, which is not limited in the present invention.

In addition, in the present embodiment, the light source 106 is disposed adjacent to the side surface (the light incident surface 104a) of the light guide plate 104, so as to be optically coupled with the light guide plate 104 to form an edge-lit structure. In this way, the backlight module 100 is a well-known edge-lit backlight module. The light source 106 may be a light emitting diode (LED) or other suitable light emitting device, which is not limited in the present invention. In the present embodiment, depending on the quantum fluorescent film 108 of the present invention, the light source 106 is a light-emitting device emitting blue light. The blue light L, which is emitted from the light source 106, enters the light guide plate 104 from the light incident surface 104a. The blue light L is then transmitted inside the light guide plate 104 through total reflection, and is emitted from the light emitting surface 104b to reach the quantum fluorescent film 108. The blue light L reaching the quantum fluorescent film 108 may be partially converted into red light and green light, so that the blue light L, the red light and the green light may be mixed into white light and transmitted to the display panel 102.

In the present embodiment, the quantum fluorescent film 108 is disposed on the light emitting surface 104b of the light guide plate 104. The quantum fluorescent film 108 is in direct contact with the light emitting surface 104b of the light guide plate 104, but the present invention is not limited thereto. In other embodiment, other components may be disposed between the quantum fluorescent film 108 and the light emitting surface 104b of the light guide plate 104, depending on the actual needs. In other embodiment, other components may be disposed between the quantum fluorescent film 108 and the display panel 102 according to actual needs.

In the present embodiment, the quantum fluorescent film 108 includes a light conversion layer 110, a first substrate 112 and a second substrate 114. The light conversion layer 110 is disposed between the first substrate 112 and the second substrate 114. The first substrate 112 and the second substrate 114 may each be a polyethylene terephthalate substrate or other suitable substrate. In the present embodiment, neither the first substrate 112 nor the second substrate 114 includes a gas barrier layer, but the present invention is not limited thereto. In other embodiments, the first substrate 112 and/or the second substrate 114 may include a gas barrier layer according to actual needs.

In addition, in other embodiments, an optical film (not shown) may be disposed between the quantum fluorescent film 108 and the display panel 102 or between the quantum fluorescent film 108 and the light guide plate 104, depending on the actual needs. The optical film may be a brightness enhancement film, a diffuser film, a polarizer film or a combination thereof.

In the present embodiment, the light conversion layer 110 includes a resin material 110a, a plurality of quantum dots 110b and a plurality of phosphors 110c. The quantum dots 110b and the phosphors 110c are uniformly dispersed in the resin material 100a. The resin material 110a may be acrylic resin, epoxy resin, silicone or a combination thereof. Furthermore, in the present embodiment, the quantum dot 110b has a core-gradient alloy layer-shell structure. The quantum dots 110b may be green quantum dots, red quantum dots or a combination thereof. In the core-gradient alloy layer-shell structure, the material of the core may be CdSe or InP, and the material of the shell may be ZnSe or ZnS. In the present embodiment, the phosphors 110c may be green phosphors, red phosphors or a combination thereof. The material of the green phosphor may be (Ba,Sr)₂SiO₄:Eu²⁺, Si_{6-z}Al_{z}O_{z}N_{8-z}:Eu²⁺, Al_{1.7}O_{2.1}N_{0.3}:Mn²⁺,Eu²⁺ or a combination thereof. The material of the red phosphor may be CaAlSiN₃:Eu²⁺, Sr₂SisN₈:Eu²⁺, K₂SiF₆:Mn⁴⁺ or a combination thereof.

In an embodiment, the quantum dot 110b is the green quantum dot and the phosphor 110c is the red phosphor. When the blue light L enters the light conversion layer 110, the green quantum dots may be excited to emit green light, and the green light emitted by the green quantum dots may have a narrower full width at half maximum (FWHM). As a result, the backlight module 100 including the quantum fluorescent film 108 may have a wider color gamut. For example, the backlight module 100 including the quantum fluorescent film 108 may have a wider color gamut than the color gamut of a backlight module including a light conversion layer containing only yellow phosphors (Y₃Al₅O₁₂:Ce).

In addition, when the blue light L enters the light conversion layer 110, the red phosphors may be excited to emit red light. The material of the red phosphor does not contain cadmium (Cd). Therefore, the quantum fluorescent film 108 may have a lower cadmium content, and the cadmium content may even be 0 ppm. Cadmium is one of the dangerous toxic heavy metals. The accumulation of cadmium in the body of living organisms may cause serious damage to the body and may cause cancer. In order to protect the health of the users and reduce environmental pollution, the European Union (EU) restriction of hazardous substances (RoHS) limits the cadmium content of the electrical and electronic apparatuses to less than 100 ppm. Obviously, although the green quantum dot in the quantum fluorescent film 108 of the present embodiment contains cadmium (the material of the core is CdSe), compared with other general quantum dot films with a wide color gamut (contains the green quantum dot and the red quantum dot with CdSe core, which have high cadmium content of about 100 ppm), the quantum fluorescent film 108 of the present embodiment may have a lower cadmium content (about 50 ppm), while still allowing the display apparatus including the quantum fluorescent film 108 to maintain a wider color gamut.

In an embodiment, the quantum fluorescent film 108 may contain green quantum dots, green phosphors and red phosphors. Since a portion of the green quantum dots is replaced with the green phosphors, the cadmium content may be further reduced to a quarter, about 25 ppm, compared with other general quantum dot film with a wide color gamut. In an embodiment, when the material of the core of the green quantum dot is InP, the quantum fluorescent film 108 does not contain cadmium, that is, the cadmium content is 0 ppm.

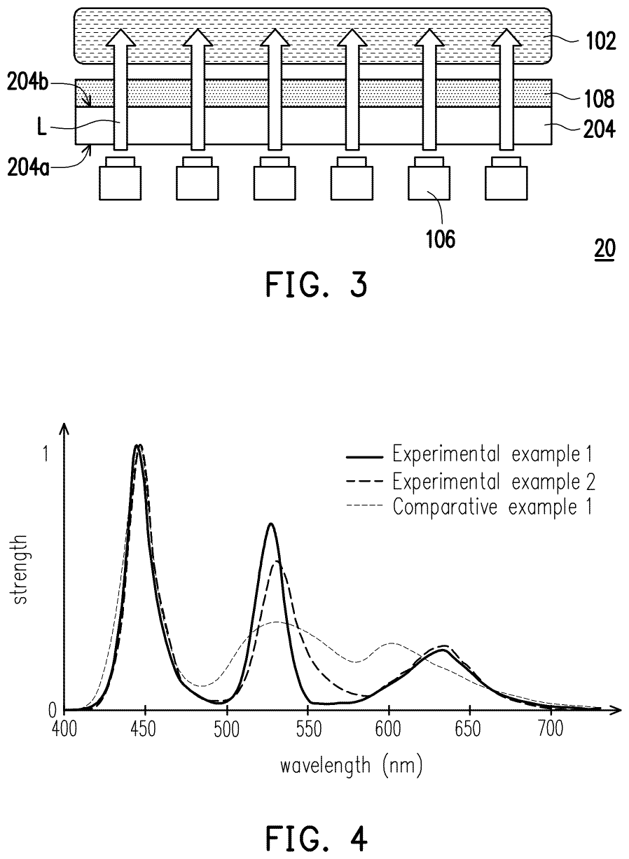

FIG. 3 is a schematic cross-sectional view of a display apparatus of the second embodiment of the present invention. In FIG. 3, the same or similar devices as those in FIG. 1 will be denoted by the same or similar reference numbers and will not be described again.

Referring to FIG. 3, in the display apparatus 20 of the present embodiment, the cross section of the light guide plate 204 has a rectangular shape. The light guide plate 204 has a light incident surface 204a and a light emitting surface 204b opposite to each other. The light sources 106 are disposed adjacent to the back surface (the light incident surface 204a) of the light guide plate 204, so as to be optically coupled with the light guide plate 204 to form a direct-lit structure. The blue light L emitted from the light sources 106 enters the light guide plate 204 from the light incident surface 204a. The blue light L is then transmitted inside the light guide plate 204, and is emitted from the light emitting surface 204b to reach the quantum fluorescent film 108. The blue light L reaching the quantum fluorescent film 108 may be partially converted into red light and green light, so that the blue light L, the red light and the green light may be mixed into white light and transmitted to the display panel 102.

The effect of the light conversion layer of the present invention will be described below with the Experimental example and the Comparative example.

### Experimental Example 1

A quantum fluorescent film containing green quantum dots and red phosphors was disposed in a backlight module, and the backlight module was assembled into a display apparatus. The green quantum dot was a quantum dot having a core-gradient alloy layer-shell structure of CdSe/ZnS. The red phosphor was nitride red phosphor (CaAlSiN₃:Eu²⁺).

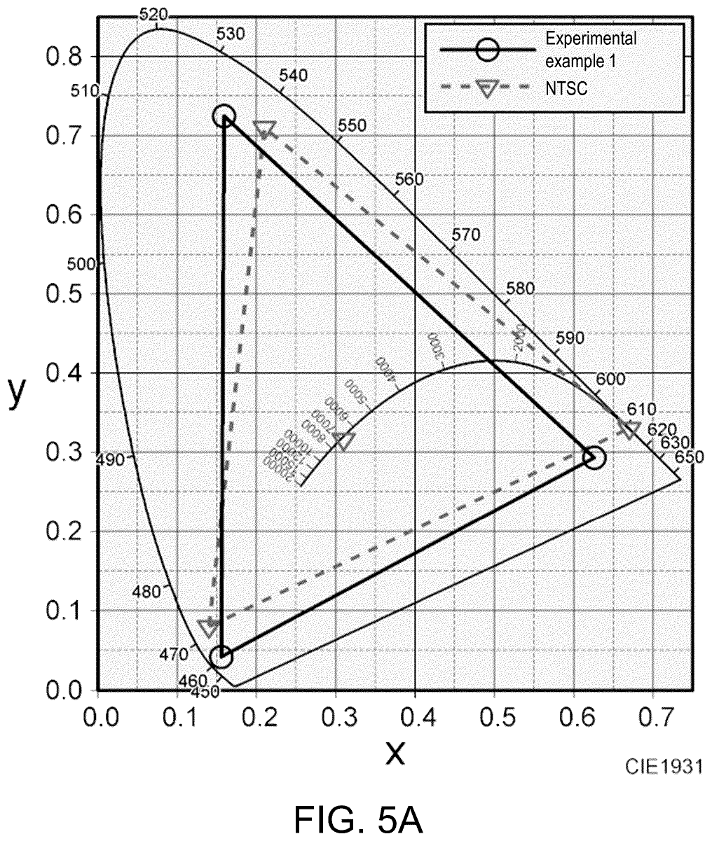

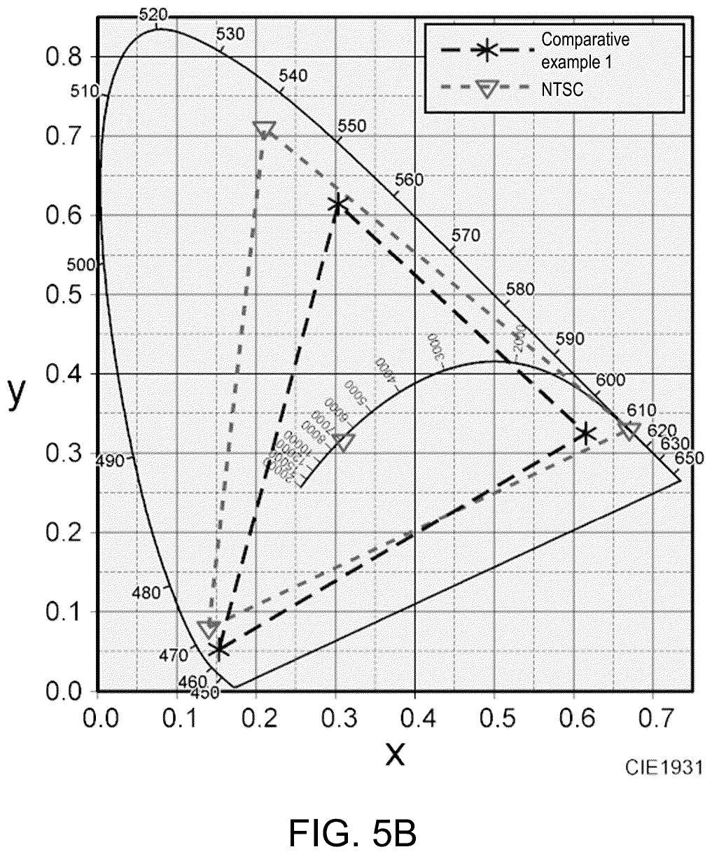

The white light emission spectrum of the display apparatus as shown in FIG. 4, the chromaticity (color gamut) diagram as shown in FIG. 5A and the color gamut as shown in Table 1 of the display apparatus were measured.

### Comparative Example 1

The white light emission spectrum as shown in FIG. 4, the chromaticity (color gamut) diagram as shown in FIG. 5B and the color gamut as shown in Table 1 of a traditional display apparatus containing yellow phosphors were measured. The yellow phosphor was the YAG phosphor (Y₃Al₅O₁₂:Ce).

As shown in Table 1 and FIGS. 5A and 5B, the color gamut of the display apparatus of the Experimental example 1 is wider, and the color gamut of the display apparatus of the Comparative example 1 is narrower.

TABLE 1

| | brightness | white light point | | color gamut | | |
|---|---|---|---|---|---|---|
| | (cd/m²) | x | y | NTSC | DCI-P3 | Adobe-RGB |
| Experimental | 230 | 0.2369 | 0.2443 | coverage 85% | coverage 82% | coverage 89% |
| example 1 | | | | area 101% | area 105% | area 106% |
| Comparative | 226 | 0.2756 | 0.2658 | coverage 66% | coverage 72% | coverage 72% |
| example 1 | | | | area 69% | area 72% | area 72% |

### Experimental Example 2

Half of the green quantum dots in the quantum fluorescent film of the Experimental example 1 were replaced with the green phosphors ((Ba,Sr)₂SiO₄:Eu²⁺), and the white light emission spectrum of the display apparatus containing the quantum fluorescent film was measured. As shown in FIG. 4, even though Experimental example 2 only used half of the amount of the quantum dots in the Experimental example 1 (i.e., cadmium content was halved) a light-emission similar to that of Experimental example 1 may also be achieved This effectively halved the cadmium content, while still maintaining the advantages of the wide color gamut of the display apparatus.

Based on the above, compared to the conventional display apparatus containing yellow phosphors, the display apparatus of the present invention may have a wider color gamut. Therefore, the display apparatus of the present invention may display colors more accurately. In addition, compared to the display apparatus with the cadmium-containing quantum dot film, the display apparatus of the present invention may maintain the advantages of the wide color gamut while reducing the cadmium content.

It will be apparent to those skilled in the art that various modifications and variations may be made to the disclosed embodiments without departing from the scope or spirit of the invention. In view of the foregoing, it is intended that the invention covers modifications and variations provided that they fall within the scope of the following claims and their equivalents.

What is claimed is:

1. A backlight module, comprising:
a quantum fluorescent film comprising a light conversion layer comprising a resin material, a plurality of quantum dots and a plurality of phosphors, wherein the plurality of quantum dots and the plurality of phosphors are dispersed in the resin material.

2. The backlight module of claim 1, further comprising:
a light source, emitting blue light; and
a light guide plate, optically coupled with the light source,
wherein the quantum fluorescent film is disposed on a light emitting surface of the light guide plate.

3. The backlight module of claim 2, wherein the light source is disposed adjacent to a side surface of the light guide plate to form an edge-lit structure.

4. The backlight module of claim 2, wherein the light source disposed is adjacent to a back surface of the light guide plate to form a direct-lit structure.

5. The backlight module of claim 1, wherein the quantum fluorescent film further comprises a first substrate and a second substrate, and the light conversion layer is disposed between the first substrate and the second substrate.

6. The backlight module of claim 5, wherein the first substrate comprises a gas barrier layer.

7. The backlight module of claim 5, wherein the first substrate does not comprise a gas barrier layer.

8. The backlight module of claim 5, wherein the second substrate comprises a gas barrier layer.

9. The backlight module of claim 5, wherein the second substrate does not comprise a gas barrier layer.

10. The backlight module of claim 1, further comprising an optical film disposed on the quantum fluorescent film.

11. The backlight module of claim 10, wherein the optical film comprises a brightness enhancement film, a diffuser film, a polarizer film or a combination thereof.

12. The backlight module of claim 1, wherein the resin material comprises acrylic resin, epoxy resin, silicone or a combination thereof.

13. The backlight module of claim 1, wherein the quantum dot has a core-gradient alloy layer-shell structure.

14. The backlight module of claim 13, wherein a material of a core of the quantum dot comprises CdSe or InP.

15. The backlight module of claim 13, wherein a material of a shell of the quantum dot comprises ZnSe or ZnS.

16. The backlight module of claim 1, wherein the plurality of quantum dots comprises green quantum dots, red quantum dots or a combination thereof.

17. The backlight module of claim 1, wherein the plurality of phosphors comprises green phosphors, red phosphors or a combination thereof.

18. The backlight module of claim 17, wherein a material of the green phosphor comprises (Ba,Sr)₂SiO₄:Eu²⁺, Si_{6-z}Al_{z}O_{z}N_{8-z}:Eu²⁺, Al_{1.7}O_{2.1}N_{0.3}:Mn²⁺,Eu²⁺ or a combination thereof.

19. The backlight module of claim 17, wherein a material of the red phosphor comprises CaAlSiN₃:Eu²⁺, Sr₂Si₅N₈:Eu²⁺, K₂SiF₆:Mn⁴⁺ or a combination thereof.

20. A display apparatus, comprising:
a display panel; and
the backlight module of claim 1, disposed on a side of the display panel.
